(19) United States
(12) Patent Application Publication
(10) Pub. No.: US 2024/0098797 A1
(43) Pub. Date: Mar. 21, 2024

(54) SYSTEMS AND METHODS FOR MANAGING SMALL DATA TRANSMISSIONS

(71) Applicant: ZTE CORPORATION, Shenzhen (CN)

(72) Inventors: Yu LIU, Shenzhen (CN); He HUANG, Shenzhen (CN)

(21) Appl. No.: 18/139,784

(22) Filed: Apr. 26, 2023

Related U.S. Application Data
(63) Continuation of application No. PCT/CN21/70949, filed on Jan. 8, 2021.

(51) Int. Cl. H04W 74/08; H04W 56/00

(52) U.S. Cl. CPC H04W 74/0833; H04W 56/0045

(57) ABSTRACT

A wireless communication method includes method including determining Small Data Transmission (SDT) information and performing, with a network, SDT procedure using the SDT information.

### CROSS-REFERENCE TO RELATED APPLICATION

This application claims the benefit of priority under 35 U.S.C. § 120 as a continuation of International Patent Application No. PCT/CN2021/070949, filed on Jan. 8, 2021, the disclosure of which is incorporated herein by reference in its entirety.

### TECHNICAL FIELD

The disclosure relates generally to wireless communications and, more particularly, to systems and methods for managing small data transmissions.

### BACKGROUND

Small-Data Transmission (SDT) allows a User Equipment (UE) to transmit (periodic and/or non-periodic) data in RRC-Inactive state without moving to RRC-Connected state. SDT can improve UE power consumption and signaling overhead.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some arrangements, User Equipment (UE) performs a method including determining Small Data Transmission (SDT) information and performing, with a network, SDT procedure using the SDT information.

In other arrangements, a BS performs a method including determining SDT information and performing, with a UE, SDT procedure using the SDT information.

In other embodiments, a wireless communications apparatus comprising a processor and a memory, wherein the processor is configured to read code from the memory and implement a method including determining SDT information and performing, with a network, SDT procedure using the SDT information.

In other embodiments, a computer program product comprising a computer-readable program medium code stored thereupon, the code, when executed by a processor, causing the processor to implement a method including determining SDT information and performing, with a network, SDT procedure using the SDT information.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a flow chart for a time alignment method in which the maintenance is time-based, according to various embodiments.

FIG. 2 is a flow chart for a time alignment method in which the maintenance is counter-based, according to various embodiments.

FIG. 3 is a flow chart for a time alignment method for maintaining the timing alignment during small data transmission, according to various embodiments.

FIG. 4 is a flow chart for a time alignment method for maintaining the timing alignment during small data transmission, according to various embodiments.

FIG. 5 is a flow chart for a time alignment method for maintaining the timing alignment during small data transmission, according to various embodiments.

FIG. 6 is a flow chart for a time alignment method for maintaining the timing alignment during small data transmission, according to various embodiments.

FIG. 7 is a flow chart for a time alignment method, according to various embodiments.

FIG. 8 is a flow chart for a time alignment method, according to various embodiments.

FIG. 9 is a flow chart for a beam management method of beam failure detection in small data transmission, according to various embodiments.

FIG. 10A is a flow chart illustrating a method for responding to beam failure, according to various embodiments.

FIG. 10B is a flow chart illustrating a method for responding to beam failure, according to various embodiments.

FIG. 10C is a flow chart illustrating a method for responding to beam failure, according to various embodiments.

FIG. 10D is a flow chart illustrating a method for responding to beam failure, according to various embodiments.

FIG. 11 is a flow chart for a method for responding to radio link failure, according to various embodiments.

FIG. 12 is a flow chart for a method for responding to radio link failure, according to various embodiments.

FIG. 13 is a flow chart for a method for responding to radio link failure, according to various embodiments.

FIG. 14 is a flow chart for a method for responding to radio link failure, according to various embodiments.

FIG. 15 is a flow chart for a method for cell re-selection for cell re-selection during small data transmission, according to various embodiments.

FIG. 16 is a flow chart for a method for cell re-selection for cell re-selection during small data transmission, according to various embodiments.

FIG. 17 is a flow chart for a method for cell re-selection for cell re-selection during small data transmission, according to various embodiments.

FIG. 18A is a flowchart diagram illustrating an example wireless communication method for small data transmission, according to various embodiments.

FIG. 18B is a flowchart diagram illustrating an example wireless communication method for small data transmission, according to various embodiments.

FIG. 19A illustrates a block diagram of an example user equipment, according to various embodiments.

FIG. 19B illustrates a block diagram of an example base station, according to various embodiments.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

Work Item in New Radio (NR) Small Data Transmissions (SDT) in RRC-Inactive state is accomplished according to one of the following solutions. In a first solution, for Uplink (UL) SDT for Random Access Channel (RACH)-based schemes (i.e., 2-step and 4-step RACH), the general procedure is to enable User Plane (UP) data transmission for small data packets from RRC-Inactive state (e.g., using MSGA or MSG3). RACH-based schemes enable flexible payload sizes larger than Common Control Channel (CCCH) message sizes that are currently possible for RRC-Inactive state for MSGA and MSG3 to support UP data transmission in UL (with actual payload size up to network configuration), and allow for context fetch and data forwarding (with or without anchor relocation) in RRC-Inactive state for RACH-based solutions. In a second solution, for transmission of UL data on pre-configured Physical Uplink Shared Channel (PUSCH) resources (i.e., re-using the configured grant type 1) and when the Time Alignment (TA) is valid, the general procedure for SDT over configured grant type 1 resources from RRC-Inactive state and the configuration of the configured grant type 1 resources for SDT in UL for RRC-Inactive state.

Configured Grant (CG)-based scheme is only applicable to intra-cell cases (i.e., the current cell is the same cell where UE enters RRC-Inactive state) and requires that a valid TA is maintained on the UE side. However, RACH-based scheme has no use restrictions. For CG-based and RACH-based schemes, there are two solutions: Radio Resource Control (RRC)-based solutions (using RRC signaling, new or old security keys) and RRC-less solutions (not using RRC signaling, old security key.

For SDT, detailed solutions for each of TA, beam management, Radio Link Failure (RLF), and cell re-selection are discussed herein.

### Time Alignment

In RRC-Connected state, the gNB is responsible for maintaining the TA to keep the Layer 1 (L1) synchronized. Similarly, the UE needs to maintain UL synchronization when transmitting and receiving data in RRC-Inactive state. A new TA timer for TA maintenance specified for configured grant based small data transfer in RRC-Inactive state should be introduced. For Further Study (FFS)] on the procedure, the validity of TA, and how to handle expiration of TA timer. The TA timer is configured together with the CG configuration in the RRCRelease message. For RACH-based scheme, parameters are usually cell-specific and configured via System Information (SI). For CG-based scheme, parameters are usually UE-specific and configured via dedicated RRC signaling. As such, there are some differences on TA processes for CG-based and RACH-based schemes.

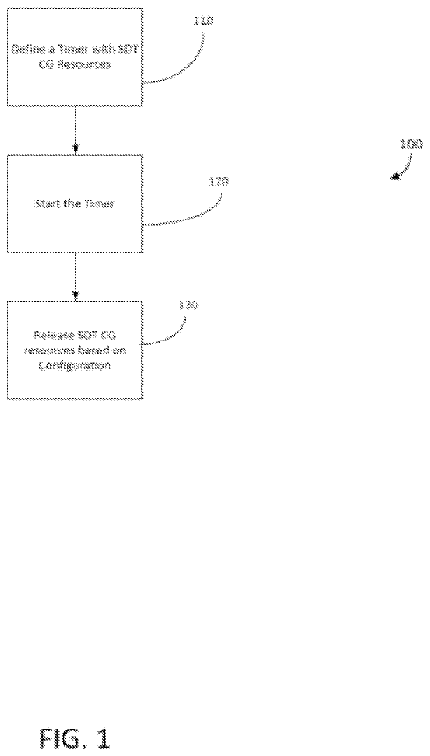

The validity of SDT CG resources can be maintained according to one or more embodiments. FIG. 1 illustrates a flow chart for a method 100 in a first embodiment in which the maintenance is time-based. As shown in FIG. 1, the method 100 is performed by a UE. The method 100 begins at block 110, where a timer is defined together with the SDT CG resources. This timer is configured by RRC for each UE, for each carrier (e.g., UL and Supplementary Uplink (SUL), or for each CG resource. Then, at block 120, once the UE receives the SDT CG configurations, the UE starts the timer. When the timer expires, the UE releases SDT resources based on the configuration at block 130. If the timer is configured for each UE, the UE releases all SDT CG resources configured in the UE. If the timer is configured for each carrier, the UE releases all SDT CG resources configured in the carrier. If the timer is configured for each CG resource, the UE releases the SDT CG resource associated with the timer.

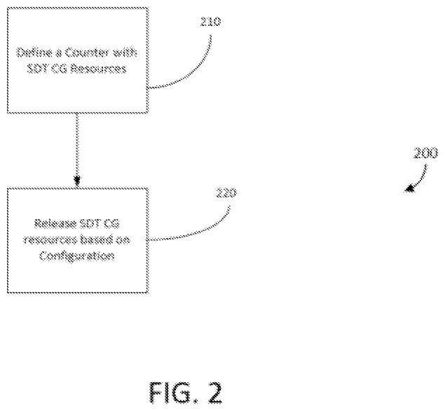

FIG. 2 illustrates a flow chart for a method 200 in a second embodiment in which the maintenance is counter-based. As shown in FIG. 2, the method 200 is performed by a UE. The method 200 begins at block 210, where the UE defines a counter (e.g., N) with SDT CG resources. The counter is configured by RRC for each UE, for each carrier (i.e., UL and SUL), or for each CG resource. During SDT procedure (i.e., after the SDT request is transmitted), when N consecutive CG occasions are skipped, the UE shall release SDT CG resources depending on the counter configuration at block 220. If the counter is configured for each UE, the UE releases all SDT CG resources configured in the UE. In this configuration, a CG occasion can only be counted according to each CG occasion of the selected CG resource, or to each CG occasion of all CG resources in the UE. If the counter is configured for each carrier, the UE releases all SDT CG resources configured in the carrier. In this configuration, a CG occasion can only be counted according to each CG occasion of the selected CG resource, or to each CG occasion of all CG resources in the current carrier. If the counter is configured for each CG resource, the UE releases the SDT CG resource associated with the counter. In this configuration, a CG occasion can only be counted according to each CG occasion of the selected CG resource, or to each CG occasion of the CG resource associated with the current counter. In either the first or second embodiment, the timer and/or counter are optional. If the timer and/or counter are not included, the CG resources are valid until the expiration of the TA timer.

Upon receiving the TA configuration for SDT, the UE starts the TA timer for SDT (e.g., timeAlignmentTimerSDT). Before SDT initiation, when timeAlignmentTimerSDT expires, the UE either releases or suspends the SDT CG configurations (i.e., the UE shall restore the SDT CG configurations when obtaining UL synchronization again). However, current methods do not account for maintaining the validity of TA and handling expiration of the TA timer during SDT. In order to maintain UL TA, the gNB needs to measure TA and send a Timing Advance Command Medium Access Control-Control Element (MAC-CE) to UE. Upon the expiration of the TA timer, the UE shall release or suspend the SDT CG configuration. Meanwhile, the UE enters IDLE state, initiates RRC re-establishment/resume procedures, or initiates a Random Access (RA) procedure (e.g., RA procedure in RRC-Connected state) while still in RRC-Inactive state. This is accomplished according to various embodiments.

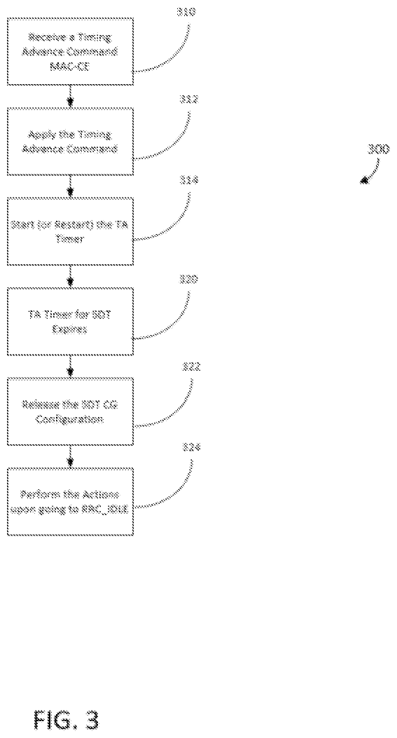

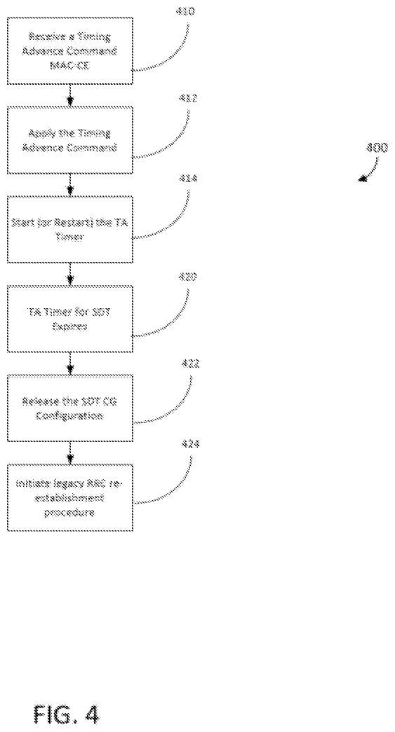

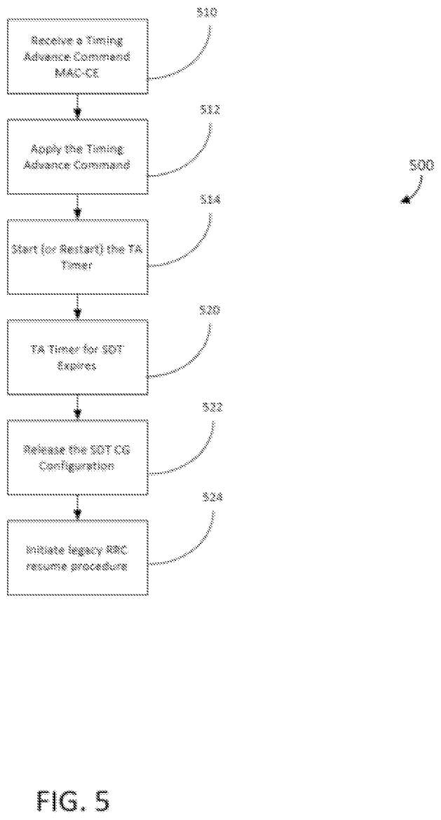

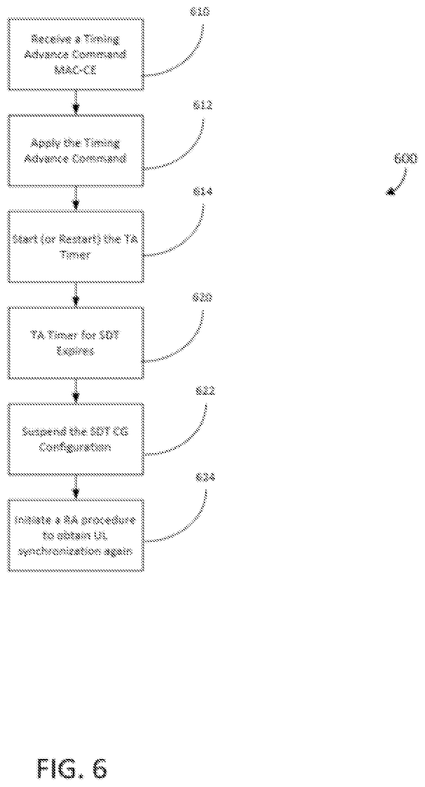

FIG. 3 illustrates a flow chart for a time alignment method 300 in a first embodiment for maintaining the TA during SDT (i.e., after the SDT request is transmitted). As shown in FIG. 3, the method 300 is performed by a MAC entity of the UE. The method 300 begins at step 310 when a Timing Advance Command MAC-CE is received. If the TA has been maintained, the MAC entity applies the Timing Advance Command at block 312 and starts (or restarts) the TA timer for SDT at block 314. Then, when the TA timer for SDT expires at block 320, the MAC entity releases the SDT CG configuration at block 322 and performs the actions upon going to RRC-Idle at block 324. FIG. 4 illustrates a flow chart for a Time alignment method 400 in a second embodiment for maintaining the TA during SDT (i.e., after the SDT request is transmitted). As shown in FIG. 4, the method 400 is performed by a MAC entity of the UE. The method 400 begins at block 410 when a Timing Advance Command MAC-CE is received. If TA has been maintained, the MAC entity applies the Timing Advance Command at block 412 and starts (or restarts) the TA timer for SDT at block 414. When the TA timer for SDT expires at block 420, the MAC entity releases the SDT CG configuration at block 422 and initiates RRC re-establishment procedure at block 424. FIG. 5 illustrates a flow chart for a Time alignment method 500 in a third embodiment for maintaining the TA during SDT (i.e., after the SDT request is transmitted). As shown in FIG. 5, the method 500 is performed by a MAC entity of the UE. The method 500 begins at block 510 when a Timing Advance Command MAC-CE is received. If the TA has been maintained, the MAC entity applies the Timing Advance Command at block 512 and starts (or restarts) the TA timer for SDT at block 514. When the TA timer for SDT expires at block 520, the MAC entity releases the SDT CG configuration at block 522 and initiates RRC resume procedure at block 524. FIG. 6 illustrates a flow chart for a Time alignment method 600 in a fourth embodiment for maintaining the TA during SDT (i.e., after the SDT request is transmitted). As shown in FIG. 6, the method 600 is performed by a MAC entity. The method 600 begins at block 610 when a Timing Advance Command MAC-CE is received. If the TA has been maintained, the MAC entity applies the Timing Advance Command at block 612 and starts (or restarts) the TA timer for SDT at block 614. When the TA timer for SDT expires at block 620, the MAC entity suspends the SDT CG configuration at block 622 and initiates a RA procedure to obtain UL synchronization again at block 624 while still in RRC-Inactive. In each of these embodiments, when the UE ends the SDT procedure and enters normal RRC-Inactive state, the UE continues to maintain timeAlignmentTimerSDT. When timeAlignmentTimerSDT expires, the UE shall release or suspend the SDT CG configurations.

In RACH-based scheme, there are two methods for configuring TA parameters used for RACH-based SDT (e.g., the TA timer is named as timeAlignmentTimerSDT SIB). In a first method, the TA parameters are broadcast via SI together with SDT RACH parameters. In a second method, the TA parameters are defined as default TA parameters. TA maintenance for RACH-based scheme is not necessary before SDT initiation because the UE uses common SDT RACH resources to initiate SDT. When initiating SDT, the UE applies the Timing Advance Command and starts timeAlignmentTimerSDT SIB upon receiving msg2/msgB, which include a Timing Advance Command. During SDT, the gNB needs to measure TA and send a Timing Advance Command MAC-CE to UE (similarly to CG-based SDT). Upon the expiration of the TA timer, the UE shall enter IDLE state, initiate RRC re-establishment/resume procedure, or initiate a RA procedure (e.g., RA procedure in RRC-Connected state) while still in RRC-Inactive state (similarly to CG-based SDT). When the UE ends the SDT procedure and enters normal RRC-Inactive state, the UE stops timeAlignmentTimerSDT SIB.

If a UE supports both CG-based and RACH-based SDT, and if the Network (NW) configures CG-based and RACH-based resources simultaneously, the UE prefers to use CG-based resources to initiate SDT. An association between CG resources and Synchronization System Blocks (SSBs) is required for CG-based SDT. A Synchronization Signal Reference Signal Received Power (SS-RSRP) threshold is configured for SSB selection. If the SS-RSRP of al SSBs associated with CG resources are below the threshold, the UE can only use RACH-based resources to initiate SDT. How to deal with TA in these situations is accomplished according to various embodiments (in which the TA timer for CG-based SDT is referred to as timeAlignmentTimerSDT and the TA timer for RACH-based SDT is referred to as timeAlignmentTimerSDT SIB).

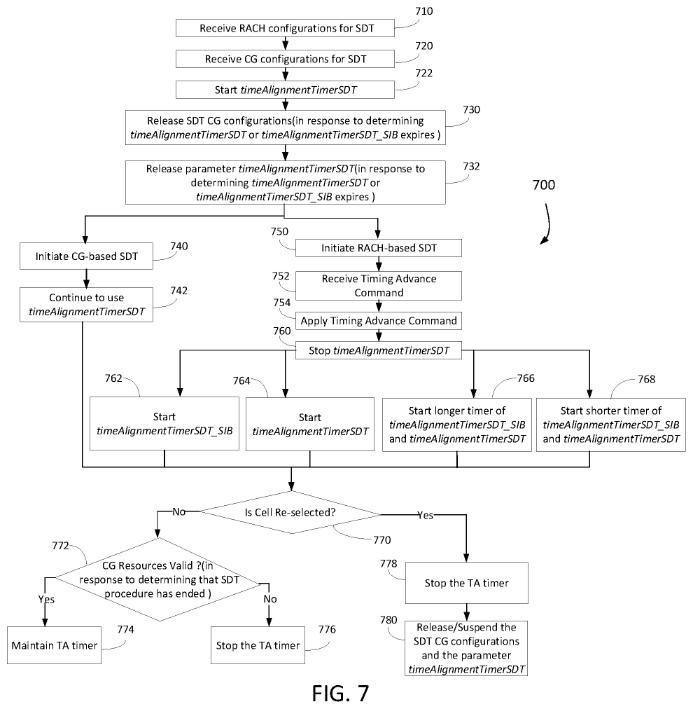

FIG. 7 is a flow chart illustrating a time alignment method 700 in a first embodiment. As shown in FIG. 7, the method 700 is performed by a UE if the UE supports both CG-based and RACH-based SDT and if the NW can configure CG-based and/or RACH-based. The method 700 begins at block 710 when the UE receives RACH configurations for SDT, which the UE. At block 720, the UE receives CG configurations for SDT, which the UE stores, and then starts timeAlignmentTimerSDT at block 722. If either timeAlignmentTimerSDT or timeAlignmentTimerSDT SIB expires, the UE releases the SDT CG configurations at block 730 and the parameter timeAlignmentTimerSDT (if present) at block 732. Then, in some embodiments, the UE initiates CG-based SDT at block 740, and continues to use timeAlignmentTimerSDT at block 742. In other embodiments, the UE initiates RACH-based SDT at block 750, receives a Timing Advance Command in msg2 or msgB at block 752, and applies the Timing Advance Command at block 754. From there, the UE also stops the timeAlignmentTimerSDT at block 760 if it is running and starts one or more of 1) timeAlignmentTimerSDT SIB at block 762; 2) timeAlignmentTimerSDT (if present, otherwise timeAlignmentTimerSDT SIB) at block 764; 3) whichever timer of timeAlignmentTimerSDT SIB and timeAlignmentTimerSDT (if present, otherwise timeAlignmentTimerSDT SIB) is longer at block 766; or 4) whichever timer of timeAlignmentTimerSDT SIB and timeAlignmentTimerSDT (if present, otherwise timeAlignmentTimerSDT SIB) is shorter at block 768. Steps 740-742 and blocks 750-768 can be performed in any order, such that blocks 740-742 are performed before blocks 750-768 in some embodiments, and blocks 750-768 are performed before blocks 740-742 in other embodiments. From there, if the UE does not re-select another cell, at block 770, the UE determines if the CG resources are valid in response to determining that SDT procedure has ended. From there, the UE maintains the TA timer at block 774 if the CG resources are valid at block 772 and stops the TA timer at block 776 otherwise. Alternatively, if the UE reselects another cell at block 770, the UE stops the TA timer (if running) at block 778 and releases/suspends the SDT CG configurations and the parameter timeAlignmentTimerSDT if present at block 780.

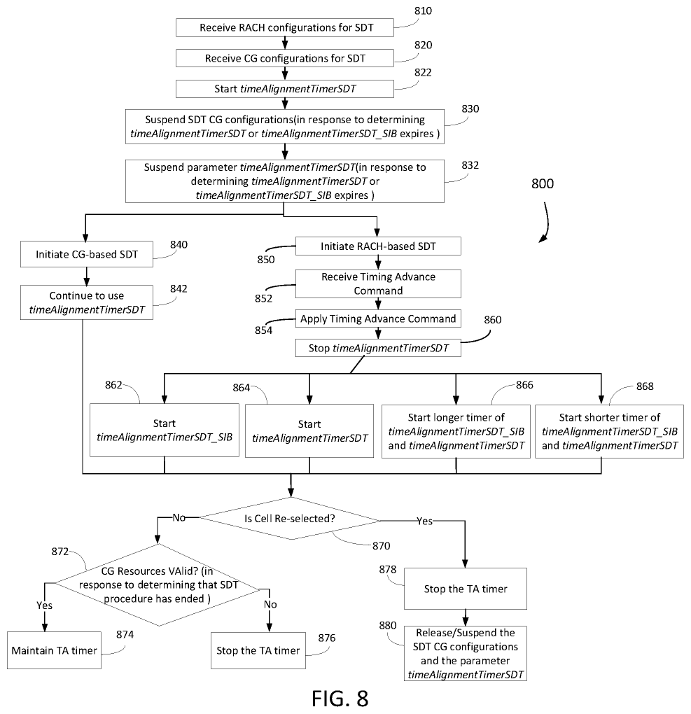

FIG. 8 is a flow chart illustrating a time alignment method 800 in a second embodiment. As shown in FIG. 8, the method 800 is performed by a UE if the UE supports both CG-based and RACH-based SDT and if the NW can configure CG-based and/or RACH-based. The method 800 begins at block 810 when the UE receives RACH configurations for SDT, which the UE. At block 820, the UE receives CG configurations for SDT, which the UE stores, and then starts timeAlignmentTimerSDT at block 822. If either timeAlignmentTimerSDT or timeAlignmentTimerSDT SIB expires, the UE suspends the SDT CG configurations at block 830 and the parameter timeAlignmentTimerSDT (if present) at block 832. Then, in some embodiments, the UE initiates CG-based SDT at block 840, and continues to use timeAlignmentTimerSDT at block 842. In other embodiments, the UE initiates RACH-based SDT at block 850, receives a Timing Advance Command in msg2 or msgB at block 852, and applies the Timing Advance Command at block 854. From there, in the example in which the SDT CG configuration is suspended, the UE resumes the SDT CG configurations and the parameter timeAlignmentTimerSDT at block 858. Then, the UE stops the timeAlignmentTimerSDT at block 860, and starts one or more of 1) timeAlignmentTimerSDT SIB at block 862; 2) timeAlignmentTimerSDT (if present, otherwise timeAlignmentTimerSDT SIB) at block 864; 3) whichever times of timeAlignmentTimerSDT SIB and timeAlignmentTimerSDT (if present, otherwise timeAlignmentTimerSDT SIB) is longer at block 866; or 4) whichever timer of timeAlignmentTimerSDT SIB and timeAlignmentTimerSDT (if present, otherwise timeAlignmentTimerSDT SIB) is longer at block 868. Blocks 840-842 and steps 850-868 can be performed in any order, such that blocks 840-842 are performed before blocks 850-868 in some embodiments, and blocks 850-868 are performed before blocks 840-842 in other embodiments. From there, if the UE does not re-select the cell, the UE determines whether the CG resources are valid in response to determining that SDT procedure has ended, at block 872. The UE maintains the TA timer at block 874 if the CG resources are valid at block 872 and stops the TA timer at block 876 otherwise. Alternatively, if the UE reselects another cell at block 870, the UE stops the TA timer (if running) at block 878 and releases/suspends the SDT CG configurations and the parameter timeAlignmentTimerSDT if present at block 880.

### Beam Management

Because NR is a multiple-antenna communication system, beam management is a basic function in NR. From RAN2 point of view: An association between CG resources and SSBs is required for CG-based SDT. FFS up to RAN1 how the association is configured or provided to the UE. Send an LS to RAN1 to start the discussion on how the association can be made. Mention that one option RAN2 considered was explicit configuration with RRC Release message.

For CG-based scheme, configuration for parameters may be given as an association between CG resources and SSBs that are explicitly configured via RRC Release message. Current methods provide for two configuration methods: associating one CG resource to one SSB, or associating one CG occasion of one CG resource to one SSB. However, further details for the configuration are FFS.

In one embodiment, the configuration entails the association of one CG resource to one SSB implicitly by configuring N CG resources or explicitly by configuring one SSB index in one CG resource. Here, the CG resources may be configured by a list (e.g., SDTConfiguredGrantConfigToAdolModList-r17), with N being equal to the number of actual transmission SSBs determined by ssb-PositionsInBurst. The first entry on the list corresponds to the first SSB transmitted in accordance with ssb-PositionsInBurst, the second entry in the list corresponds to the second SSB transmitted in accordance with ssb-PositionsInBurst, and so on.

In another embodiment, the configuration entails the association of one CG occasion of one CG resource to one SSB implicitly by supposing that the number of actual transmission SSBs determined by ssb-PositionsInBurst is equal to N or explicitly by configuring M SSB indexes in one CG resource (configured by a list, e.g., SDTConfiguredGrantConfigToAdolModList-r 17). Here, each N continuous CG occasions in one CG resource correspond to N SSBs, starting from the first CG occasion of the CG resource. The first CG occasion in each N continuous CG occasions corresponds to the first SSB transmitted in accordance with ssb-PositionsInBurst, the second CG occasion in each N continuous CG occasions corresponds to the second SSB transmitted in accordance with ssb-PositionsInBurst, and so on. Further, each M continuous CG occasions in one CG resource correspond to M SSBs, starting from the first CG occasion of the CG resource. The first CG occasion in each M continuous CG occasions corresponds to the first entry of SSB-IndexList, the second CG occasion in each M continuous CG occasions corresponds to the second entry of SSB-IndexList, and so on. For either embodiment, the gNB needs to configure parameters used for beam failure detection and beam failure recovery via RRCRelease with suspendConfig on the same Bandwidth Part (BWP) on which CG resources are configured. Optionally, the gNB can configure Transmission Configuration Indicator (TCI)-state for Physical Downlink Control Channel (PDCCH) and Physical Downlink Shared Channel (PDSCH) for SDT.

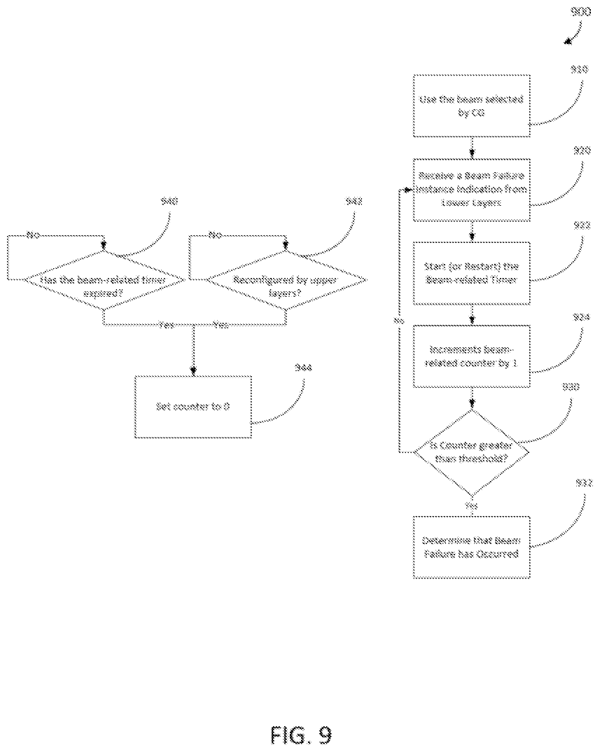

In some examples, for beam failure detection, the gNB configures the UE with beam failure detection reference signals (SSB or Channel State Information Reference Signal (CSI-RS)), and the UE declares beam failure when the number of beam failure instance indications from the physical layer reaches a configured threshold before a configured timer expires. FIG. 9 illustrates a flow chart for a beam management method 900 of beam failure detection in SDT, according to an example embodiment. As shown in FIG. 9, the method 900 is performed by a MAC entity of the UE. The method 900 begins at block 910 where the UE uses the beam selected by CG. Then, during SDT (i.e., after the SDT request is transmitted), the UE receives a beam failure instance indication from lower layers at block 920. From there, the MAC entity of the UE starts (or restarts) the beam-related timer (e.g., beamFailureDetectionTimerSDT) at block 922 and increments the beam-related counter by 1 (e.g., BEI-COUNTER_SDT) at block 924. Finally, if the counter is greater than or equal to the threshold (e.g., BEI-COUNTER_SDT>beamFailureInstanceMaxCountSDT) at block 930, the UE determines at block 932 that beam failure has occurred. Operating in parallel, if beamFailureDetectionTimerSDT expires at block 940 or if beamFailureDetectionTimerSDT, beamFailureInstanceMaxCountSDT, or any of the reference signals used for beam failure detection is reconfigured by upper layers at block 942, the UE, at block 944, sets BFI_COUNTER_SDT to 0.

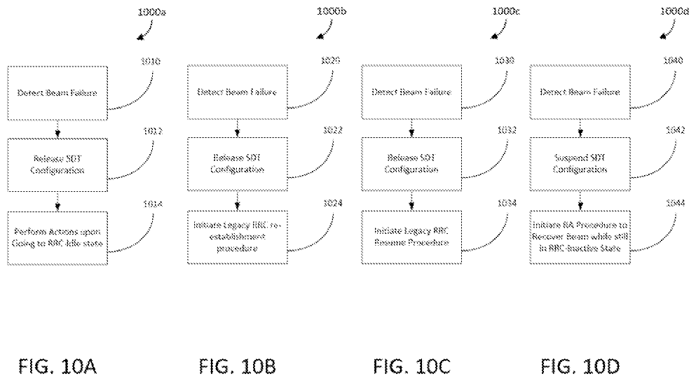

Beam Failure Recovery (BFR) may be accomplished in SDT according to various embodiments. FIG. 10A is a flow chart illustrating a method 1000a for responding to beam failure, according to a first embodiment. As shown in FIG. 10A, the method 1000a is performed by a UE. The method 1000a begins at block 1010, where the UE detects beam failure. At block 1012, the UE releases the SDT CG configuration, and, at block 1014, performs the actions upon going to RRC-Idle state. FIG. 10B is a flow chart illustrating a method 1000b for responding to beam failure, according to a second embodiment. As shown in FIG. 10B, the method 1000b is performed by a UE. The method 1000b begins at block 1020, where the UE detects beam failure. At block 1022, the UE releases the SDT CG configuration, and, at block 1024, initiates RRC re-establishment procedure. FIG. 10C is a flow chart illustrating a method 1000c for responding to beam failure, according to a third embodiment. As shown in FIG. 10c, the method 1000c is performed by a UE. The method 1000c begins at block 1030, where the UE detects beam failure. At block 1032, the UE releases the SDT CG configuration, and, at block 1034, initiates RRC resume procedure. FIG. 10D is a flow chart illustrating a method 1000d for responding to beam failure, according to a fourth embodiment. As shown in FIG. 10D, the method 1000d is performed by a UE. The method 1000d begins at block 1040, where the UE detects beam failure. At block 1042, the UE suspends the SDT CG configuration, and, at block 1044, initiates a RA procedure to recover the beam while still in RRC-Inactive state.

In RACH-based scheme, because the UE uses common resources to initiate SDT, beam failure detection and beam failure recovery are not supported due to the simplicity of common resources.

### Radio Link Failure

In RRC_CONNECTED, the UE performs Radio Link Monitoring (RLM) in the active BWP based on reference signals (either SSB or CSI-RS) and signal quality threshold configured by the NW. The UE performs RLM and RLF-related processes for SDT. For CG-based scheme, the gNB configures RLM-related parameters for SDT (e.g., RadioLinkMonitoringConfigforSDT) via RRCRelease with suspendConfig on the same BWP on which CG resources are configured. When a UE initiates SDT request, the UE starts a timer (e.g., SDT_Timer) and enters SDT procedure. During SDT, when receiving “out-of-sync” and “in-sync” indications from lower layers, there are two methods for dealing with such indications. In the first method, upon receiving Nxxx consecutive “out-of-sync” indications from lower layers while SDT_Timer is not running, the UE starts a timer (e.g., Txxx). Upon receiving Nyyy consecutive “in-sync” indications from lower layers while Txxx is running, the UE stops timer Txxx. When Txxx expires, the UE declares RLF. In the second method, upon receiving Nxxx consecutive “out-of-sync” indications from lower layers (regardless of a status of SDT_Timer), the UE starts a timer (e.g., Txxx). Upon receiving Nyyy consecutive “in-sync” indications from lower layers while Txxx is running, the UE stops timer Txxx. When Txxx expires, the UE declares RLF. In either method, Nxxx, Nyyy and Txxx are newly introduced for SDT, or parameters may be re-used (e.g., N310, N311, and T310).

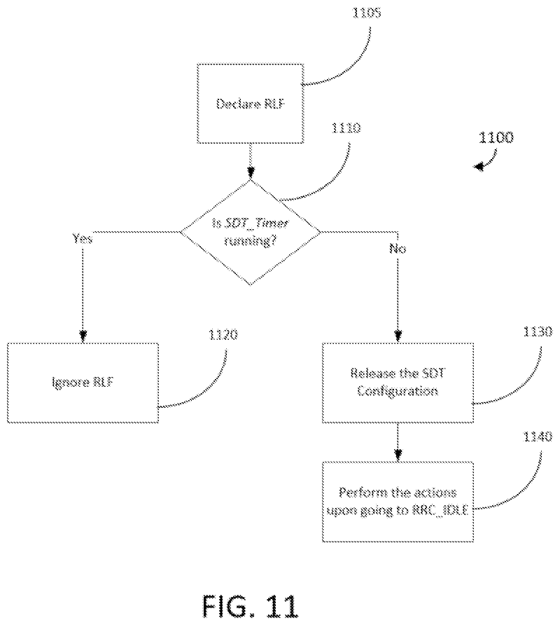

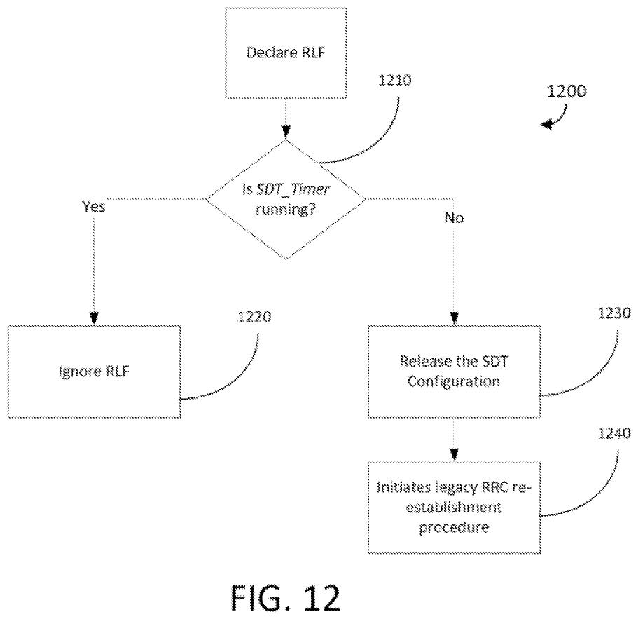

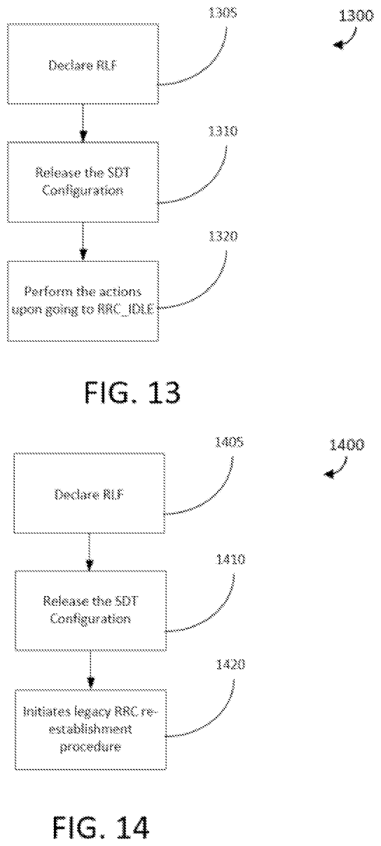

The UE declares RLF during SDT when one or more of the following criteria are met: 1) expiration of a radio problem timer (e.g., Txxx); 2) RA procedure failure; or 3) RLC failure. When RLF is declared during SDT, the UE deals with RLF according to various embodiments. FIG. 11 is a flowchart illustrating a method 1100 for responding to RLF, according to a first embodiment. As shown in FIG. 11, the method 1100 is performed by a UE. The method 1100 begins at block 1105, where the UE declares RLF. The method 1100 continues at block 1110, where the UE determines if the SDT_Timer is running after RLF is declared during SDT (i.e., after an SDT request is transmitted). If the timer is running, the UE ignores the RLF at block 1120. If the timer is not running, the UE releases the SDT CG configuration at block 1130 and performs the actions upon going to RRC-Idle at block 1140. FIG. 12 is a flowchart illustrating a method 1200 for responding to RLF, according to a second embodiment. As shown in FIG. 12, the method 1200 is performed by a UE. The method 1200 begins at block 1205, where the UE declares RLF. The method 1200 continues at block 1210, where the UE determines if the SDT_Timer is running after RLF is declared during SDT (i.e., after an SDT request is transmitted). If the timer is running, the UE ignores the RLF at block 1220. If the timer is not running, the UE releases the SDT CG configuration at 1230 and initiates RRC re-establishment procedure at block 1240. FIG. 13 is a flowchart illustrating a method 1300 for responding to RLF, according to a third embodiment. As shown in FIG. 13, the method 1300 is performed by a UE. The method 1300 begins at block 1305, where the UE declares RLF. The method 1300 continues at block 1310, where the UE releases the SDT CG configuration and performs the actions upon going to RRC-Idle at block 1320. FIG. 14 is a flowchart illustrating a method 1400 for responding to RLF, according to a fourth embodiment. As shown in FIG. 14, the method 1400 is performed by a UE. The method 1400 begins at block 1405, where the UE declares RLF. The method 1400 continues at block 1410, where the UE releases the SDT CG configuration and initiates RRC re-establishment procedure at block 1420.

For RACH-based scheme, because the UE uses common resources to initiate SDT, RLM is not supported due to the simplicity of the common resources, so the gNB does not configure RLM parameters for RACH-based SDT. However, even though the UE does not support RLM, the UE can support RLF-related processes. During SDT, the UE declares RLF when there is either RA procedure failure or RLC failure. When RLF is declared during SDT, the UE deals with it according to various embodiments. In a first embodiment, after RLF is declared during SDT, the UE ignores it if SDT_Timer is running, or releases the SDT CG configuration (if configured) and performs the actions upon going to RRC-Idle if otherwise. In a second embodiment, after RLF is declared during SDT, the UE ignores it if SDT_Timer is running or releases the SDT CG configuration (if configured) and initiates RRC re-establishment procedures if otherwise. In a third embodiment, after RLF is declared during SDT, the UE releases the SDT CG configuration (if configured) and performs the actions upon going to RRC-Idle. In a fourth embodiment, after RLF is declared during SDT, the UE releases the SDT CG configuration (if configured) and initiates RRC re-establishment procedure.

### Cell Re-Selection

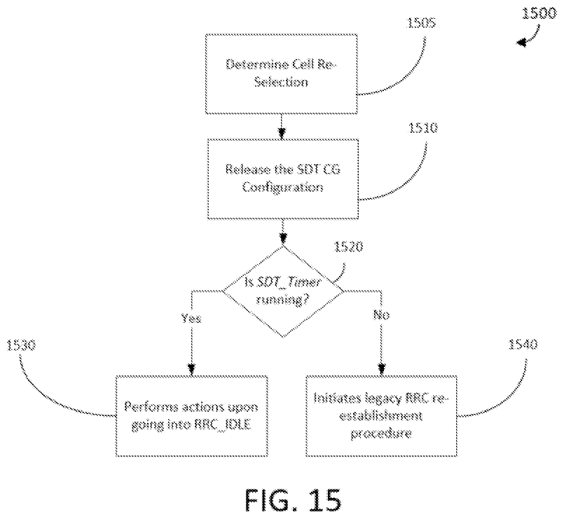

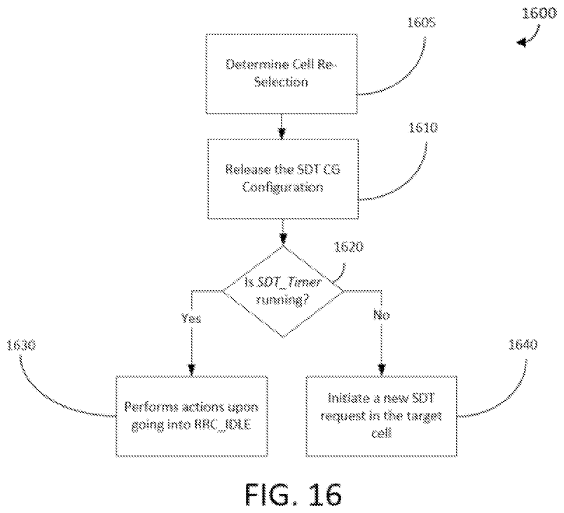

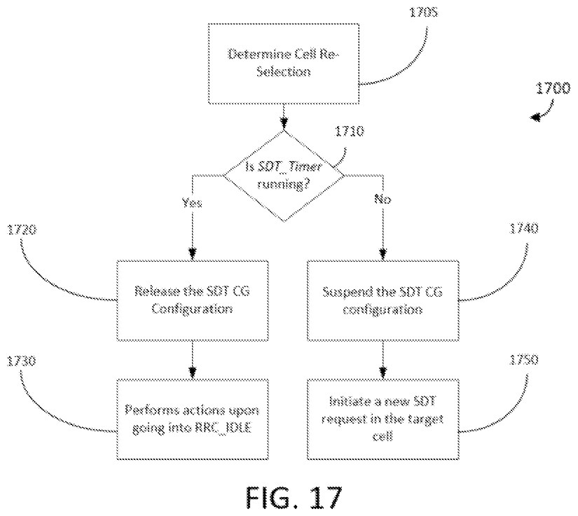

When a UE initiates SDT request, the UE starts a timer (e.g., SDT_Timer) and enters SDT procedure. The UE may move to another cell during SDT, so the UE may need to perform cell re-selection related measurement and assessment. When moving to another cell during SDT, the UE may act according to various embodiments. FIG. 15 illustrates a flow chart of a method 1500 for cell re-selection, according to a first embodiment in which cell re-selection occurs during SDT. As shown in FIG. 15, the method 1500 is performed by a UE. The method begins at block 1505, where the UE determines that cell re-selection is occurring. The method 1500 continues at block 1510, where the UE releases the SDT CG configuration (if configured). Then, at block 1520, the UE determines if SDT_Timer is running. If the time is running, the UE performs the actions upon going into RRC-Idle at block 1530, or initiates RRC re-establishment procedure at block 1540 if the timer is not running. FIG. 16 illustrates a flow chart of a method 1600 for cell re-selection, according to a second embodiment in which cell re-selection occurs during SDT. As shown in FIG. 16, the method 1600 is performed by a UE. The method begins at block 1605, where the UE determines that cell re-selection is occurring. The method 1600 continues at block 1610, where the UE releases the SDT CG configuration (if configured). Then, at block 1620, the UE determines if SDT_Timer is running. If the time is running, the UE performs the actions upon going into RRC-Idle at block 1630, or initiates a new SDT request in the target cell (if the target cell supports SDT) at block 1640 if the timer is not running. FIG. 17 illustrates a flow chart of a method 1700 for cell re-selection, according to a third embodiment in which cell re-selection occurs during SDT. As shown in FIG. 17, the method 1700 is performed by a UE. The method begins at block 1705, where the UE determines that cell re-selection is occurring. The method 1700 continues at block 1710, where the UE determines if SDT_Timer is running. If the time is running, the UE releases the SDT CG configuration (if configured) a block t 1720 and performs the actions upon going into RRC-Idle at block 1730. If the timer is not running, the UE suspends, at block 1740, the SDT CG configuration (if configured) (i.e., the UE shall restore the SDT CG configuration when returning the previous cell and obtaining UL synchronization again), and initiates a new SDT request in the target cell (if the target cell supports SDT) at block 1750.

In a fourth embodiment, if cell re-selection occurs during SDT, the UE releases the SDT CG configuration (if configured) and performs the actions upon going to RRC-Idle. In a fifth embodiment, if cell re-selection occurs during SDT, the UE releases the SDT CG configuration (if configured) and initiates RRC re-establishment procedure. In a sixth embodiment, if cell re-selection occurs during SDT, the UE releases the SDT CG configuration (if configured) and initiates a new SDT request in the target cell (if the target cell supports SDT). In a seventh embodiment, if cell re-selection occurs during SDT, the UE (if the target cell supports SDT) suspends the SDT CG configuration (if configured) (i.e., the UE restores the SDT CG configuration when returning the previous cell and obtaining UL synchronization again) and initiates a new SDT request in the target cell.

For each of the second, third, sixth, and seventh embodiments, if the UE initiates a new SDT request in the target cell, the UE needs to confine the re-use number of NextHopChainingCount (NCC) due to security concerns from UE re-using NCC configured in the previous RRCRelease for the target cell. To address this, the UE may configure the re-use number of NCC in RRCRelease or define a default number.

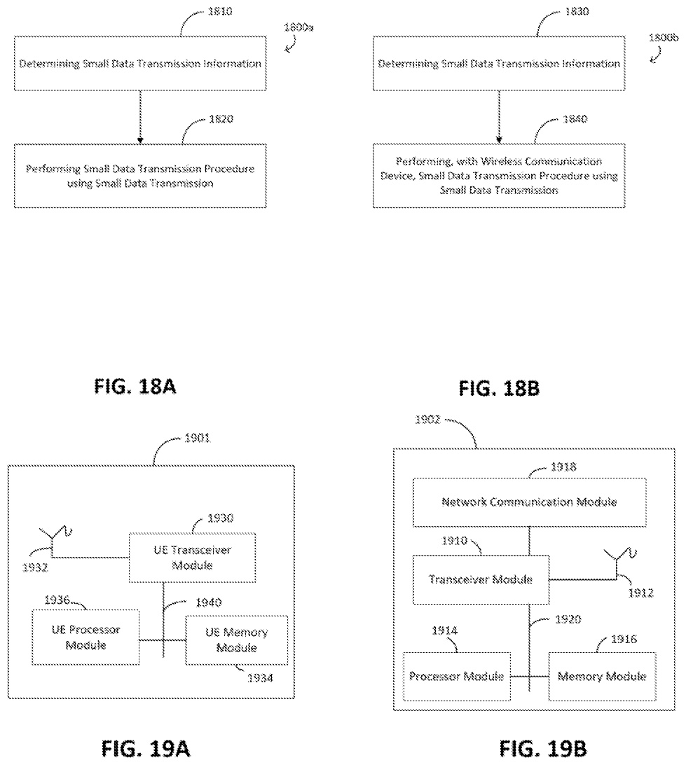

FIG. 18A is a flowchart diagram illustrating an example wireless communication method 1800a, according to various arrangements. Method 1800a can be performed by a UE, and begins at block 1810 where the UE determines SDT information. At block 1820, the UE performs, with a network, SDT procedure using the SDT information.

FIG. 18B is a flowchart diagram illustrating an example wireless communication method 1800b, according to various arrangements. Method 1800b can be performed by a network (e.g., BS), and begins at block 1830 where the network determines SDT information. At block 1840, the network performs, with a UE, SDT procedure using the SDT information.

FIG. 19A illustrates a block diagram of an example UE 1901, in accordance with some embodiments of the present disclosure. FIG. 19B illustrates a block diagram of an example BS 1902, in accordance with some embodiments of the present disclosure. The UE 1901 (e.g., a wireless communication device, a terminal, a mobile device, a mobile user, and so on) is an example implementation of the UEs described herein, and the BS 1902 is an example implementation of the BS described herein.

The BS 1902 and the UE 1901 can include components and elements configured to support known or conventional operating features that need not be described in detail herein. In one illustrative embodiment, the BS 1902 and the UE 1901 can be used to communicate (e.g., transmit and receive) data symbols in a wireless communication environment, as described above. For instance, the BS 1902 can be a BS (e.g., gNB, eNB, and so on), a server, a node, or any suitable computing device used to implement various network functions.

The BS 1902 includes a transceiver module 1910, an antenna 1912, a processor module 1914, a memory module 1916, and a network communication module 1918. The module 1910, 1912, 1914, 1916, and 1918 are operatively coupled to and interconnected with one another via a data communication bus 1920. The UE 1901 includes a UE transceiver module 1930, a UE antenna 1932, a UE memory module 1934, and a UE processor module 1936. The modules 1930, 1932, 1934, and 1936 are operatively coupled to and interconnected with one another via a data communication bus 1940. The BS 1902 communicates with the UE 1901 or another BS via a communication channel, which can be any wireless channel or other medium suitable for transmission of data as described herein.

As would be understood by persons of ordinary skill in the art, the BS 1902 and the UE 1901 can further include any number of modules other than the modules shown in FIGS. 19A and 19B. The various illustrative blocks, modules, circuits, and processing logic described in connection with the embodiments disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The embodiments described herein can be implemented in a suitable manner for each particular application, but any implementation decisions should not be interpreted as limiting the scope of the present disclosure.

In accordance with some embodiments, the UE transceiver 1930 includes a radio frequency (RF) transmitter and a RF receiver each including circuitry that is coupled to the antenna 1932. A duplex switch (not shown) may alternatively couple the RF transmitter or receiver to the antenna in time duplex fashion. Similarly, in accordance with some embodiments, the transceiver 1910 includes an RF transmitter and a RF receiver each having circuitry that is coupled to the antenna 1912 or the antenna of another BS. A duplex switch may alternatively couple the RF transmitter or receiver to the antenna 1912 in time duplex fashion. The operations of the two-transceiver modules 1910 and 1930 can be coordinated in time such that the receiver circuitry is coupled to the antenna 1932 for reception of transmissions over a wireless transmission link at the same time that the transmitter is coupled to the antenna 1912. In some embodiments, there is close time synchronization with a minimal guard time between changes in duplex direction.

The UE transceiver 1930 and the transceiver 1910 are configured to communicate via the wireless data communication link, and cooperate with a suitably configured RF antenna arrangement 1912/1932 that can support a particular wireless communication protocol and modulation scheme. In some illustrative embodiments, the UE transceiver 1930 and the transceiver 1910 are configured to support industry standards such as the Long Term Evolution (LTE) and emerging 5G standards, and the like. It is understood, however, that the present disclosure is not necessarily limited in application to a particular standard and associated protocols. Rather, the UE transceiver 1930 and the BS transceiver 1910 may be configured to support alternate, or additional, wireless data communication protocols, including future standards or variations thereof.

The transceiver 1910 and the transceiver of another BS (such as but not limited to, the transceiver 1910) are configured to communicate via a wireless data communication link, and cooperate with a suitably configured RF antenna arrangement that can support a particular wireless communication protocol and modulation scheme. In some illustrative embodiments, the transceiver 1910 and the transceiver of another BS are configured to support industry standards such as the LTE and emerging 5G standards, and the like. It is understood, however, that the present disclosure is not necessarily limited in application to a particular standard and associated protocols. Rather, the transceiver 1910 and the transceiver of another BS may be configured to support alternate, or additional, wireless data communication protocols, including future standards or variations thereof.

In accordance with various embodiments, the BS 1902 may be a BS such as but not limited to, an eNB, a serving eNB, a target eNB, a femto station, or a pico station, for example. The BS 1902 can be an RN, a DeNB, or a gNB. In some embodiments, the UE 1901 may be embodied in various types of user devices such as a mobile phone, a smart phone, a personal digital assistant (PDA), tablet, laptop computer, wearable computing device, etc. The processor modules 1914 and 1936 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 1914 and 1936, respectively, or in any practical combination thereof. The memory modules 1916 and 1934 may be realized as RAM memory, flash memory, ROM memory, EPROM memory, EEPROM memory, registers, a hard disk, a removable disk, a CD-ROM, or any other form of storage medium known in the art. In this regard, memory modules 1916 and 1934 may be coupled to the processor modules 1914 and 1936, respectively, such that the processors modules 1914 and 1936 can read information from, and write information to, memory modules 1916 and 1934, respectively. The memory modules 1916 and 1934 may also be integrated into their respective processor modules 1914 and 1936. In some embodiments, the memory modules 1916 and 1934 may each include a cache memory for storing temporary variables or other intermediate information during execution of instructions to be executed by processor modules 1914 and 1936, respectively. Memory modules 1916 and 1934 may also each include non-volatile memory for storing instructions to be executed by the processor modules 1914 and 1936, respectively.

The network communication module 1918 generally represents the hardware, software, firmware, processing logic, and/or other components of the BS 1902 that enable bi-directional communication between the transceiver 1910 and other network components and communication nodes in communication with the BS 1902. For example, the network communication module 1918 may be configured to support internet or WiMAX traffic. In a deployment, without limitation, the network communication module 1918 provides an 502.3 Ethernet interface such that the transceiver 1910 can communicate with a conventional Ethernet based computer network. In this manner, the network communication module 1918 may include a physical interface for connection to the computer network (e.g., Mobile Switching Center (MSC)). In some embodiments, the network communication module 1918 includes a fiber transport connection configured to connect the BS 1902 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
determining, by a wireless communication device, Small Data Transmission (SDT) information; and
performing, by the wireless communication device with a network, SDT procedure using the SDT information.

2. The wireless communication method of claim 1, wherein
the SDT information comprises SDT Configured Grant (CG) configuration; and
the wireless communication method comprises:
receiving, from the network, Time Alignment (TA) information;
in response to receiving the TA information, initiating, by the wireless communication device, a timer; and
in response to determining that the timer has expired, releasing, by the wireless communication device, SDT CG resources.

3. The wireless communication method of claim 1, wherein
the SDT information comprises SDT Configured Grant (CG) configuration; and
the wireless communication method comprises:
receiving, from the network, Time Alignment (TA) information; and
in response to receiving the TA information and determining that the TA information is maintained:
applying the TA information; and
starting or restarting a timer.

4. The wireless communication method of claim 1, wherein
the SDT information comprises SDT Random Access Channel (RACH) configuration; and
the wireless communication method comprises:
receiving, from the network, Time Alignment (TA) information with the SDT RACH configuration.

5. The wireless communication method of claim 1, wherein the SDT information comprises SDT Random Access Channel (RACH) configuration, and the wireless communication method comprises:
in initiating the SDT procedure, applying first Time Alignment (TA) information and initiating a timer;
during performing the SDT procedure, in response to determining that the timer is not running:
initiating a Random Access (RA) procedure in which uplink synchronization is obtained in a RRC-Inactive state; and
in response to determining that the SDT procedure ends and that the wireless communication device enters into a Radio Resource Control (RRC)-Inactive state, terminating the timer,
wherein the timer is reinitiated in response to receiving any TA information.

6. The wireless communication method of claim 1, wherein
the SDT information comprises SDT Configured Grant (CG) configuration and SDT Random Access Channel (RACH) configuration; and
using the SDT RACH configuration for the SDT procedure in response to determining that using the SDT CG configuration has failed.

7. The wireless communication method of claim 6, wherein a first timer corresponds to the SDT CG configuration, and a second timer corresponds to the SDT RACH configuration; and the wireless communication method further comprises:
in response to determining that the first timer has expired, release SDT CG resources;
in response to initiating the SDT procedure using the SDT RACH configuration and receiving from the network, Time Alignment (TA) information:
apply the TA information;
stop the first timer; and
starting the second timer;
in response to determining that another cell of the network has been selected:
stopping the first timer or the second timer; and
releasing or suspending the SDT CG configurations; and
in response to determining that the SDT procedure has ended and the wireless communication device is set to a Radio Resource Control (RRC)-Inactive state:
maintaining the first timer or the second timer upon determining that CG resources are valid; and
stopping the first timer or the second timer upon determining that the CG resources are invalid.

8. The wireless communication method of claim 1, comprising determining, during performing the SDT procedure, that Radio Link Failure (RLF) has occurred in response to determining at least one of:
a Random Access (RA) procedure failure, or
a Radio Link Control (RLC) failure.

9. The wireless communication method of claim 8, comprising:
in response to determining that the RLF has occurred during performing the SDT procedure:
releasing the SDT CG configuration, and setting the wireless communication device to the RRC-Idle state.

10. The wireless communication method of claim 1, comprising: in response to determining that the cell-reselection has occurred during performing the SDT procedure:
releasing SDT Configured Grant (CG) configuration; and
setting the wireless communication device to a Radio Resource Control (RRC)-Idle state.

11. A wireless communication device, comprising:
at least one processor configured to:
determine Small Data Transmission (SDT) information; and
perform, with a network, SDT procedure using the SDT information.

12. The wireless communication device of claim 11, wherein
the SDT information comprises SDT Configured Grant (CG) configuration; and
the at least one processor is configured to:
receive, from the network, Time Alignment (TA) information;
in response to receiving the TA information, initiate, by the wireless communication device, a timer; and
in response to determining that the timer has expired, release SDT CG resources.

13. The wireless communication device of claim 11, wherein
the SDT information comprises SDT Configured Grant (CG) configuration; and
the at least one processor is configured to:
receive, from the network, Time Alignment (TA) information; and
in response to receiving the TA information and determining that the TA information is maintained:
apply the TA information; and
start or restart a timer.

14. The wireless communication device of claim 11, wherein
the SDT information comprises SDT Random Access Channel (RACH) configuration; and
the at least one processor is configured to:
receive, from the network, Time Alignment (TA) information with the SDT RACH configuration.

15. The wireless communication device of claim 11, wherein the SDT information comprises SDT Random Access Channel (RACH) configuration, and the at least one processor is configured to:
in initiating the SDT procedure, apply first Time Alignment (TA) information and initiating a timer;
during performing the SDT procedure, in response to determining that the timer is not running:
initiate a Random Access (RA) procedure in which uplink synchronization is obtained in a RRC-Inactive state; and
in response to determining that the SDT procedure ends and that the wireless communication device enters into a Radio Resource Control (RRC)-Inactive state, terminate the timer,
wherein the timer is reinitiated in response to receiving any TA information.
